(19) United States
(12) Patent Application Publication
(10) Pub. No.: US 2011/0158754 A1
(43) Pub. Date: Jun. 30, 2011

(54) AUTOMATIC MATERIAL FEEDER

(75) Inventors: SI-LEI YU, Shenzhen City (CN); WEN-SHU LIU, Shenzhen City (CN); YU-WEN LUO, Shenzhen City (CN)

(73) Assignees: FU TAI HUA INDUSTRY (SHENZHEN) CO., LTD., ShenZhen City (CN); HON HAI PRECISION INDUSTRY CO., LTD., Tu-Cheng (TW)

(21) Appl. No.: 12/872,168

(22) Filed: Aug. 31, 2010

(30) Foreign Application Priority Data
Dec. 29, 2009 (CN) 200910312598.7

(51) Int. Cl. B65G 53/40

(52) U.S. Cl. 406/115

(57) ABSTRACT

An automatic material feeder includes a feeding member defining a feeding track, a driver, a sliding member driven by the driver and defining a latch portion and a transportation portion communicating with the latch portion, a gas generator, an air intake conduit connected to the gas generator, and a delivery conduit. The sliding member transfers material from the feeding track to a position where the latch portion corresponds to the delivery conduit, and the transportation portion communicates with the air intake conduit, and the gas generator generates gas to force the material received in the latch portion to enter the delivery conduit.

### BACKGROUND

1. Technical Field

The present disclosure relates to an automatic material feeder.

2. Description of Related Art

A frequently used automatic material feeder includes a vibrating bowl and an inclined helical track extending from a top edge of the vibrating bowl. Fasteners such as screws are received in the vibrating bowl. When the vibrating bowl is vibrating, the fasteners are continuously upended and fed onto the helical track, for delivery to a requisite location.

However, while the automatic material feeder is capable of aligning the fasteners, conveyance thereof to an exact desired location is troublesome.

Therefore, there is room for improvement within the art.

### BRIEF DESCRIPTION OF THE DRAWINGS

The components in the drawings are not necessarily drawn to scale, the emphasis instead being positioned upon clearly illustrating the principles of the present disclosure. Moreover, in the drawings, like reference numerals designate corresponding parts throughout the views.

FIG. 1 is an assembled, isometric view of an embodiment of an automatic material feeder.

FIG. 2 is an exploded, isometric view of the automatic material feeder of FIG. 1.

FIG. 3 is similar to FIG. 2, but viewed from another aspect.

### DETAILED DESCRIPTION

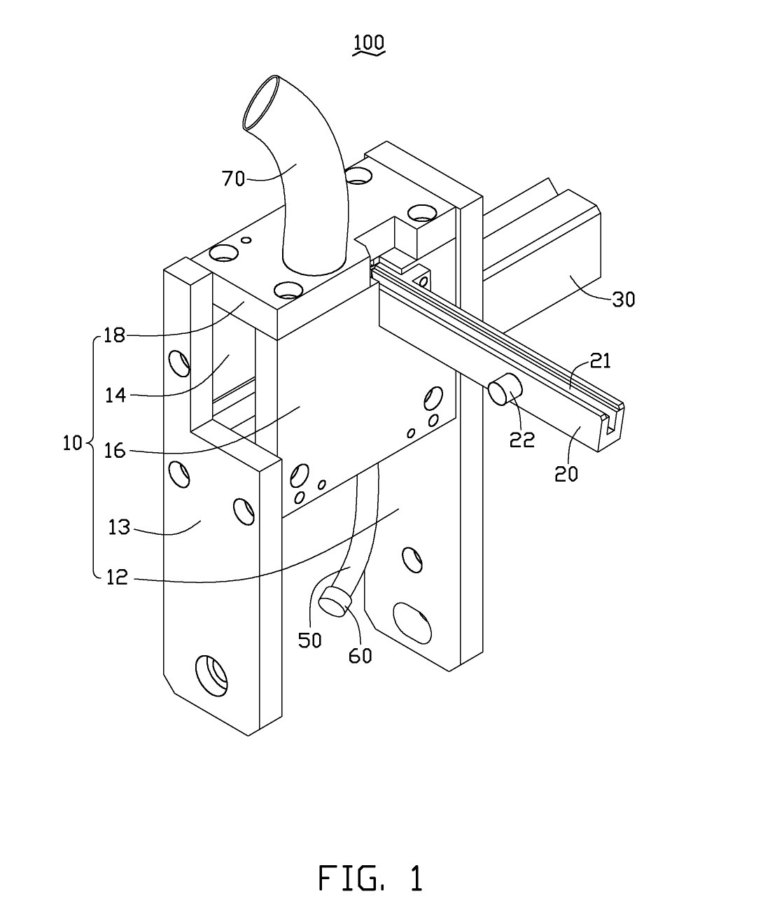

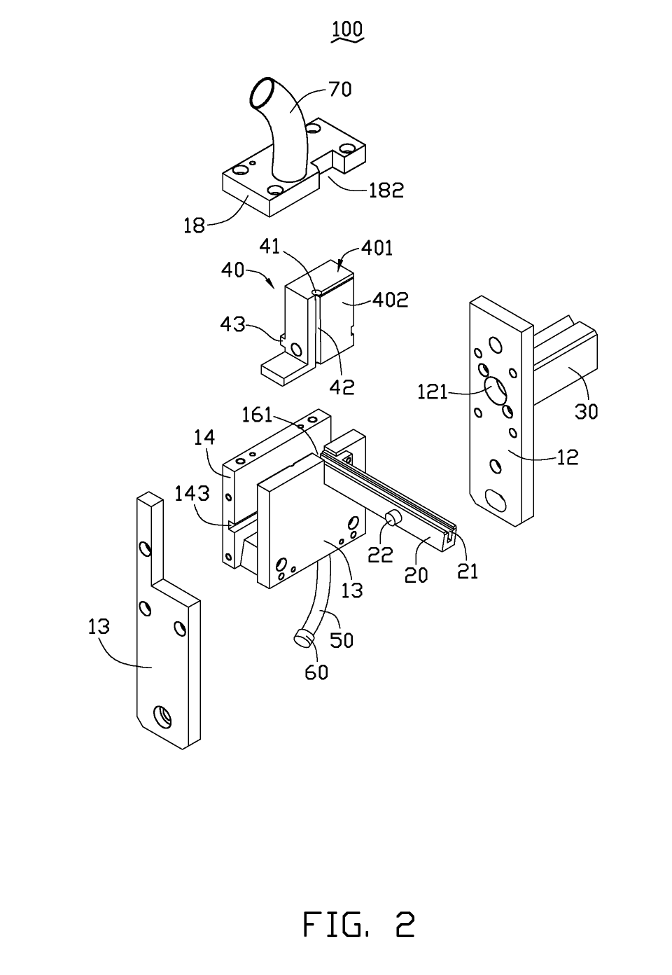

Referring to FIG. 1 and FIG. 2, an embodiment of an automatic material feeder 100 includes a base 10, a feeding member 20, a driver 30, a sliding member 40 connected to the driver 30, an air intake conduit 50, a gas generator 60, and a delivery conduit 70. The feeding member 20 is connected to the base 10. The sliding member 40 is slidably connected to the base 10, and driven by the driver 30. An end of the air intake conduit 50 is connected to the gas generator 60. An opposite end of the air intake conduit 50 is connected to the base 10. The delivery conduit 70 is connected to the base 10.

The base 10 includes a first supporting member 12, a second supporting member 13, a first fixing member 14, a second fixing member 16, and a cover 18. Each of the first supporting member 12 and the second supporting member 13 can be a substantially flat board aligned with and substantially parallel to each other. The first supporting member 12 defines a through hole 121 in the middle of the first supporting member 12.

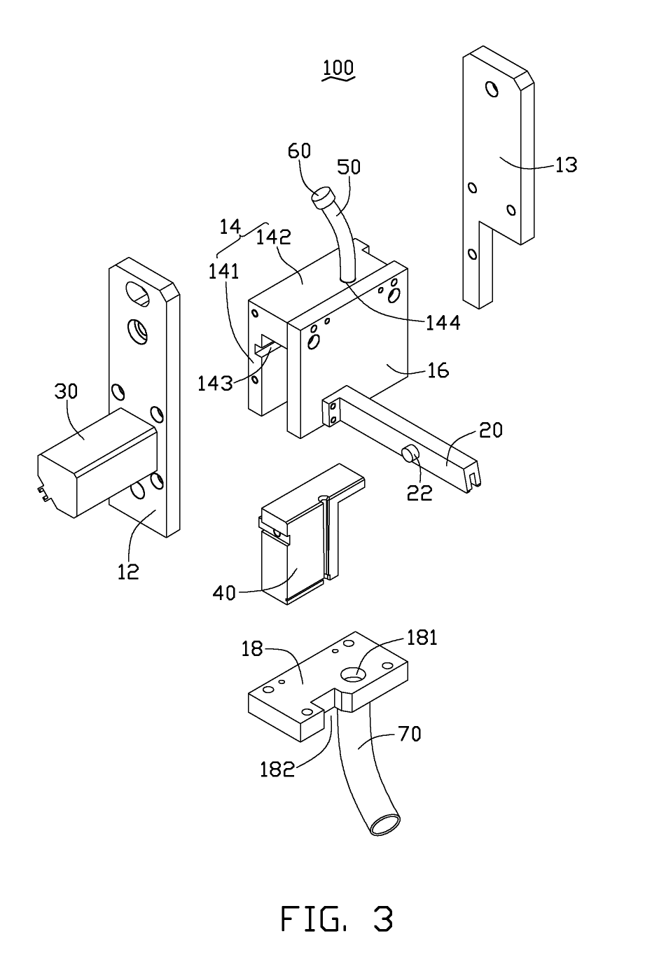

Referring to FIG. 3, the first fixing member 14 is a substantially L-shaped board. The first fixing member 14 is positioned between the first supporting member 12 and the second supporting member 13. One end of the first fixing member 14 is fixed to the first supporting member 12. An opposite end of the fixing member 14 is fixed to the second supporting member 13. The first fixing member 14 includes a side board 141 and a bottom board 142 extending from an edge of the side board 141. The bottom board 142 is substantially perpendicular to the side board 141. Each of the side board 141 and the bottom board 142 is substantially perpendicular to the first supporting member 12 and the second supporting member 13. The side board 141 defines a sliding slot 143 extending substantially perpendicular to the second supporting member 13. The bottom board 142 defines an inlet hole 144 through which air intake conduit 50 passes.

The second fixing member 16 can be a substantially rectangular board. The second fixing member 16 is positioned between the first supporting member 12 and the second supporting member 13, substantially parallel to the side board 141. One end of the second fixing member 16 is fixed to the first supporting member 12, and an opposite end of the second fixing member 16 is fixed to the second supporting member 13. The second fixing member 16 abuts an end of the bottom board 142 away from the side board 141. The second fixing member 16 defines a fixing groove 161 depressed from one top surface of the second fixing member 16, and the top surface is substantially parallel to the bottom board 142. The fixing groove 161 passes through two opposite side surfaces substantially parallel to the side board 141.

The cover 18 can be a substantially rectangular board positioned between the first supporting member 12 and the second supporting member 13. The cover 18 is fixed to an end of the side board 141 away from the bottom board 142 and an end of the second fixing member 16. The cover 18 defines an outlet hole 181 substantially coaxial with the inlet hole 144 through which the delivery conduit 70 passes, and a secondary recess 182 corresponding to the fixing groove 161.

The feeding member 20 can be rod-shaped and having a substantially rectangular cross section. The feeding member 20 defines a feeding track 21 depressed from a side surface of the feeding member 20 longitudinally along the feeding member 20. An end of the feeding member 20 is secured in the fixing groove 161, and an opposite end of the feeding member 20 is connected to a feeding device (not shown). In the illustrated embodiment, the feeding device is a vibrating bowl. The feeding member 20 further includes a sensor 22 positioned at the feeding member 20. The sensor 22 is electrically connected to the feeding member 20. Once a number of fasteners in the feeding track 21 determined by the sensor 22 reaches a predetermined value, the sensor 22 will stop the feeding device from delivering fasteners to the feeding member 20, increasing efficiency thereof.

The driver 30 is fixed to a side of the first supporting member 12 away from the second supporting member 13 corresponding to the through hole 121. In the illustrated embodiment, the driver 30 is a cylinder. Alternatively, the driver 30 may be a motor.

The sliding member 40 is a substantially rectangular block. The sliding member 40 is slidably positioned between the second fixing member 16 and the first fixing member 14. The sliding member 40 is connected to the driver 30 via the through hole 121 of the first supporting member 12. The sliding member 40 includes an end surface 401 substantially parallel to the cover 18, a side surface 402 substantially perpendicular to the end surface 401, a latch portion 41, a transportation portion 42, and a sliding portion 43. The latch portion 41 can be an arcuate recess depressed from the end surface 401 and passing through the side surface 402. A radius of the arcuate recess decreases away from the end surface 401. The transportation portion 42 can be a recess depressed from the side surface 402 and communicating with the latch portion 41. The transportation portion 42 extends from an end of the latch portion 41 away from the end surface 401 and passes through an end surface opposite to the end surface 401. The sliding portion 43 can be an elongated protrusion protruding from a side surface (not labeled) opposite to the side surface 402 and extending substantially perpendicular to the second supporting member 13. The sliding portion 43 corresponds to the sliding slot 143 in shape, but a length of the sliding portion 43 is less than that of the sliding slot 143.

An end of the air intake conduit 50 away from the bottom board 142 is connected to the gas generator 60. The gas generator 60 is configured to provide gas. In use, a free end of the delivery conduit 70 may support an effector applying the fasteners.

In use, the sliding member 40 is driven by the driver 30 slide along the sliding slot 143 until the latch portion 41 communicates with the feeding track 21 of the feeding member 20, and one fastener is received in the feeding track 21 is received in the latch portion 41. The sliding member 40 is further slid by the driver 30 until the latch portion 41 corresponds to the outlet hole 181 of the cover 18, and the transportation portion 42 is received in the inlet hole 144. A jet of air from a gas generator 60 through the air intake conduit 50 and the transportation portion 42 forces the fastener into the delivery conduit 70, and finally to the mounted effector. After the fasteners reach the effector, the sliding member 40 returns to a position wherein the latch portion 41 communicates with the feeding track 21, and an end surface opposite to the end surface 401 abuts the bottom board 142 to close the inlet hole 144.

The sliding member 40 is capable of retrieving one fastener at a time from the feeding track 21 and relocating to a position in which the latch portion 41 corresponds to the outlet hole 181 in the cover 18, the transportation portion 42 communicates with the inlet hole 144, and air from the gas generator 60 relocates the fastener to the exact position needed.

It should be pointed out that two or more outlet holes 181, rather than one, such as the two outlet holes 181 can be defined in the cover 18, respectively, whereby the number of the delivery conduits 70 are changed accordingly, so that the automatic material feeder 100 is capable of feeding fasteners to different positions.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An automatic material feeder, comprising:
a feeding member comprising a feeding track;
a driver;
a sliding member driven by the driver and comprising a latch portion and a transport portion communicating with the latch portion;
a gas generator;
an air intake conduit connected to the gas generator; and
a delivery conduit, wherein the sliding member is capable of sliding to transfer material from the feeding track to a position the latch portion corresponding to the delivery conduit, and the transport portion communicates with the air intake conduit; the gas generator generates gas to force the material received in the latch portion to enter the delivery conduit.

2. The automatic material feeder of claim 1, wherein the feeding member further comprises a sensor to determine a unit number of material received in the feeding track.

3. The automatic material feeder of claim 1, further comprising a base comprising a first supporting member and a first fixing member substantially perpendicular to the first supporting member, an end of the first fixing member being fixed to the first supporting member, wherein the driver is fixed to the first supporting member, which defines a sliding slot in which a sliding portion is slidably received.

4. The automatic material feeder of claim 3, wherein the first fixing member comprises a side board and a bottom board extending substantially perpendicular thereto a sliding slot defined in the side board extending substantially parallel to the bottom board, which defines an inlet hole communicating with the air intake conduit, and an end surface of the sliding member abuts the bottom board.

5. The automatic material feeder of claim 4, further comprising a second fixing member substantially perpendicular to the first supporting member, abutting an end of the bottom board away from the side board, and the second fixing member defines a fixing groove in which an end of the feeding member is received.

6. The automatic material feeder of claim 5, further comprising a second supporting member substantially parallel to the first supporting member, wherein an end of the first fixing member away from the first supporting member is fixed to the second supporting member, and an end of the second fixing member away from the first supporting member is fixed to the second supporting member.

7. The automatic material feeder of claim 6, further comprising a cover positioned between the first supporting member and the second supporting member, and fixed to an end of the side board of the first fixing member away from the bottom board and an end of the second fixing member, wherein the cover defines an outlet hole communicating with the delivery conduit.

8. The automatic material feeder of claim 7, wherein the cover further defines a secondary recess corresponding to the fixing groove.

9. The automatic material feeder of claim 5, wherein the latch portion is an arcuate recess depressed from the end surface of the sliding member opposite to the end surface abutting the bottom board, and passing through a side surface of the sliding member facing the second fixing member.

10. The automatic material feeder of claim 9, wherein the transportation portion is a recess depressed from the side surface of the sliding member.

11. The automatic material feeder of claim 1, wherein the driver is a cylinder.

12. The automatic material feeder of claim 1, wherein the driver is a motor.
